(19) United States
(12) Patent Application Publication
(10) Pub. No.: US 2019/0112870 A1
(43) Pub. Date: Apr. 18, 2019

(54) VENETIAN BLINDS WITH SUCTION CUPS

(71) Applicant: Kimaco Nichols, San Antonio, TX (US)

(72) Inventor: Kimaco Nichols, San Antonio, TX (US)

(21) Appl. No.: 16/153,978

(22) Filed: Oct. 8, 2018

Related U.S. Application Data
(60) Provisional application No. 62/572,739, filed on Oct. 16, 2017.

(51) Int. Cl. E06B 9/32; E06B 9/266; E06B 9/386; F16B 47/00

(52) U.S. Cl. CPC E06B 9/32; F16B 47/00; E06B 9/386; E06B 9/266

(57) ABSTRACT

Venetian blinds to cover a window having a window frame and a window pane, the venetian blinds including a plurality of panels interconnected with each other, a cord to pivot the plurality of panels in a first pivoting direction to allow sunlight to be visible through the plurality of panels, and a second pivoting direction to prevent the sunlight from being visible through the plurality of panels, and a plurality of suction cups disposed on surfaces of the plurality of panels facing the window.

### BACKGROUND

### 1. Field

The present general inventive concept relates generally to venetian blinds, and particularly, to venetian blinds with suction cups.

### 2. Description of the Related Art

Installing new blinds and shades is among a myriad of quick improvements that immediately adds personality to a home. Specifically, venetian blinds provide simple window treatments to block out light and add style. However, conventional venetian blinds sometimes allow beams of sunlight to shine therethrough, especially if a window that they are covering is open and wind blows the blinds, thereby causing them to move.

Therefore, there is a need for venetian blinds that do not move when in use.

### SUMMARY

The present general inventive concept provides venetian blinds with suction cups.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing venetian blinds to cover a window having a window frame and a window pane, the venetian blinds including a plurality of panels interconnected with each other, a cord to pivot the plurality of panels in a first pivoting direction to allow sunlight to be visible through the plurality of panels, and a second pivoting direction to prevent the sunlight from being visible through the plurality of panels, and a plurality of suction cups disposed on surfaces of the plurality of panels facing the window.

At least some of the plurality of suction cups may be disposed at outer portions of the plurality of panels.

At least some of the plurality of suction cups may be disposed lengthwise along a surface of a base panel of the plurality of panels.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an angled perspective view of venetian blinds partially covering a window, according to an exemplary embodiment of the present general inventive concept; and

FIG. 16 illustrates an angled perspective view of the venetian blinds fully covering the window, according to an exemplary embodiment of the present general inventive concept.

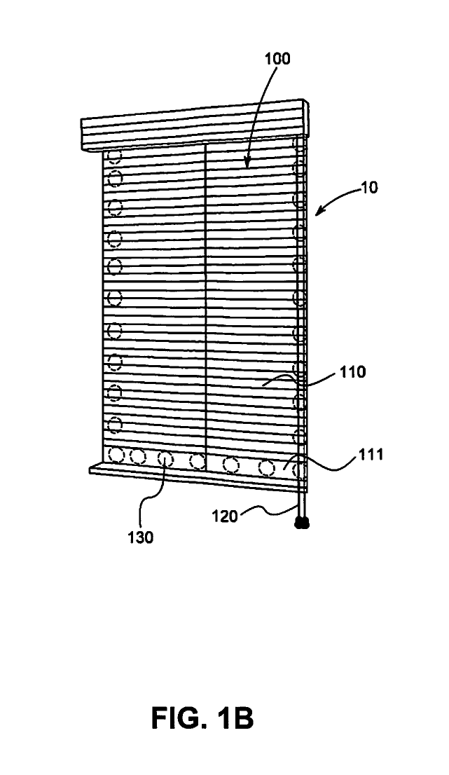

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

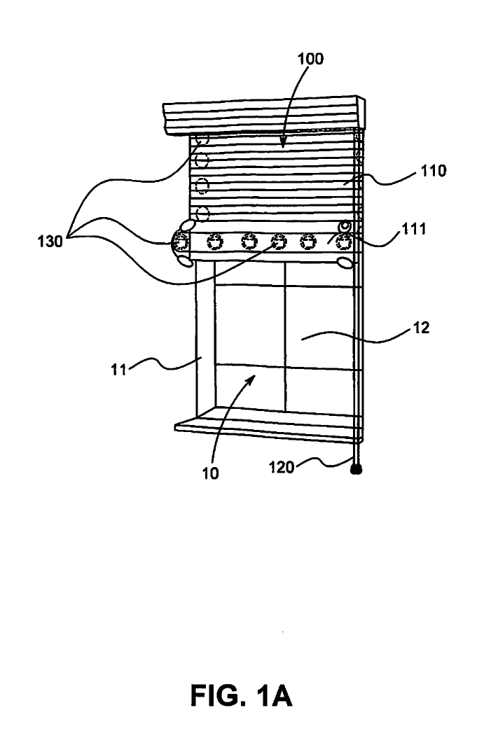

FIG. 1A illustrates an angled perspective view of venetian blinds 100 partially covering a window 10, according to an exemplary embodiment of the present general inventive concept.

FIG. 1B illustrates an angled perspective view of the venetian blinds 100 fully covering the window 10, according to an exemplary embodiment of the present general inventive concept.

The venetian blinds 100 may include a plurality of panels 110, a cord 120, and a plurality of suction cups 130, but are not limited thereto.

The plurality of panels 110 may be constructed from plastic, glass, metal, bamboo, wood, rubber, or any other material known to one of ordinary skill in the art. Preferably, the plurality of panels 110 may be constructed from material that blocks out the sun when the panels 110 are in a closed position.

The plurality of panels 110 may be interconnected to each other using any type of connectors known to one of ordinary skill in the art, including, but not limited to, string, rope, cord, rubber bands, staples, etc.

The cord 120 may be connected to the panels 110 to cause the plurality of panels 110 to move. Specifically, the cord 120 may cause the plurality of panels 110 to pivot in a first pivoting direction (i.e., open) when the cord 120 is pulled in a first direction, may cause the plurality of panels 110 to roll upwards when the cord 120 is continued to be pulled in the first direction, may cause the plurality of panels 110 to roll downwards when the cord 120 is pulled in a second direction, and may cause the plurality of panels 110 to pivot in a second pivoting direction (i.e., close) when the cord 120 is continued to be pulled in the second direction. As such, the cord 120 may be used to pivot the plurality of panels 110 in the first pivoting direction to allow sunlight to be visible through the plurality of panels, and the cord 120 may be used to pivot the plurality of panels 110 in the second pivoting direction to prevent the sunlight from being visible through the plurality of panels 110. In other words, the combination of the plurality of panels 110 and the cord 120 may operate like conventional venetian blinds known to one of ordinary skill in the art.

The plurality of suction cups 130 may be disposed on window-facing surfaces of at least some of the plurality of panels 110. Specifically, the plurality of suction cups 130 may be designed to allow at least some of the plurality of panels 110 to stick to either a window frame 11 or a window pane 12 of the window 10, and may be disposed along side portions of at least some of the plurality of panels 110. Furthermore, at least some of the plurality of suction cups 130 may be disposed along an entirety of a base panel 111 (i.e., bottom panel) of the plurality of panels 110. In other words, at least some of the plurality of suction cups 130 may be disposed lengthwise along a surface of the base panel 111 of the plurality of panels 110. As such, the base panel 111 may include a row of suction cups 130 that may allow the base panel 111 to stick to a bottom portion of the window frame 11 or a bottom portion of the window pane 12.

When the cord 120 is continuously pulled in the first direction, thereby causing the plurality of panels 110 to open and then roll upwards, as illustrated in FIG. 1A, the plurality of suction cups 130 may detach from the window frame 11 or the window pane 12, and be rolled up within the rolled up plurality of panels 110.

Referring to FIG. 1B, when the plurality of panels 110 are fully unrolled, the plurality of panels may stick to the window frame 11 or the window pane 12 via the plurality of suction cups 130.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. Venetian blinds to cover a window having a window frame and a window pane, the venetian blinds comprising:
a plurality of panels interconnected with each other;
a cord to pivot the plurality of panels in a first pivoting direction to allow sunlight to be visible through the plurality of panels, and a second pivoting direction to prevent the sunlight from being visible through the plurality of panels; and
a plurality of suction cups disposed on surfaces of the plurality of panels facing the window.

2. The venetian blinds of claim 1, wherein at least some of the plurality of suction cups are disposed at outer portions of the plurality of panels.

3. The venetian blinds of claim 2, wherein at least some of the plurality of suction cups are disposed lengthwise along a surface of a base panel of the plurality of panels.
